(19) United States
(12) Patent Application Publication
(10) Pub. No.: US 2006/0108390 A1
(43) Pub. Date: May 25, 2006

(54) ARTICULATING PUSHER ASSEMBLY

(76) Inventors: John W. Schnell, Jackson, TN (US); John M. Beville, Jackson, TN (US)

Correspondence Address: THE BLACK & DECKER CORPORATION, 701 EAST JOPPA ROAD, TW199, TOWSON, MD, 21286, US

(21) Appl. No.: 10/665,172

(22) Filed: Sep. 17, 2003

Related U.S. Application Data
(60) Provisional application No. 60/411,563, filed on Sep. 18, 2002.
(60) Provisional application No. 60/471,641, filed on May 19, 2003.

(51) Int. Cl. B25C 5/06

(52) U.S. Cl. 227/120

(57) ABSTRACT

An articulating pusher assembly, disposed within a nail loading assembly, includes an articulating pusher coupled to an adapter, the articulating pusher for engaging a nail. The adapter may be further coupled with a casing which engages a spool assembly to provide a constant pressure on the articulating pusher assembly to advance the nail down the length of the nail loading assembly. The articulating pusher is enabled to accommodate the use of a variety of nail types and collation angles of nail strips within the nail loading assembly.

### CROSS REFERENCE TO RELATED APPLICATION

The present application claims priority under 35 U.S.C. §119(e) to the U.S. Provisional Application Ser. No. 60/411,563, filed on Sep. 18, 2002, and the U.S. Provisional Application Ser. No. 60/471,641, filed on May 19, 2003. The U.S. Provisional Application 60/411,563 and 60/471,641 are herein incorporated by reference in their entireties.

### FIELD OF THE INVENTION

The present invention generally relates to the field of power tools and particularly to an assembly enabling nail guns to use a variety of nail types collated into nail strips with various collation angles.

### BACKGROUND OF THE INVENTION

The inside of a nail gun magazine typically includes a mechanism for providing a driving force to collated nails stored within. The driving force pushes the collated nails down the length of the nail gun magazine to a nose casting coupled with a nail driving assembly. The driving force keeps a constant pressure on the collated nails so that as one nail is driven by a driver blade of the nail gun magazine, the next nail is forced into the nose casting to replace it. Unfortunately, many of the systems employed to provide this driving force are limited in application to a specific nail type or nail strips with specific collation angles.

Generally, the segment which engages the nails of the mechanisms employed to provide the driving force is set in a fixed position relative to the nail gun magazine and the nails. Thus, a full engagement with the nail by this segment occurs only when the nail is provided at a proper angle. When a different angle of presentation is provided by the nail, the segment is enabled to provide only a partial engagement. This partial engagement may lead to improper feeding of the nails into the nail driving assembly which may result in harm to the nail gun.

Therefore, it would be desirable to provide a mechanism which enables full engagement with nails loaded into a nail gun regardless of the nails angle of presentation.

### SUMMARY OF THE INVENTION

Accordingly, the present invention is directed to an articulating pusher assembly which provides a mechanism for fully engaging nails in an adjustable angle magazine for a nail gun. An articulating pusher assembly disposed within an adjustable angle magazine decreases the risk of misfire due to improper loading of the nails to the nail gun by providing an even pressure to the nails. The adjustable angle magazine enables the nail gun to use various types of nails which may be collated into magazines at various angles. The articulating pusher assembly is enabled to adjust to the varying nail types and collation angles to provide for full engagement. This adjustment ability is enabled through an articulating pusher which may pivot to provide full engagement with the nail. The articulating pusher is engaged by an adapter that remains in a fixed angle relative to the adjustable angle magazine but at the same time allows the articulating pusher to freely adjust.

The articulating pusher assembly may be coupled with a casing that provides a fixed connection with the adjustable angle magazine. The casing provides a modular unit, including the articulating pusher assembly, which is enabled to slide along the length of the adjustable angle magazine. A constant pressure is provided to the articulating pusher assembly through a spool assembly coupled with the casing and the adjustable angle magazine. The spool assembly translates its tensile strength into a constant pressure for engagement with the nails stored in the adjustable angle magazine.

Employed with a nail gun, the adjustable angle magazine including the articulating pusher assembly may increase the productivity of the nail gun. Further, fatigue caused by improper nail gun use may be reduced as the nails receive an even constant pressure placing them into firing position. This may avoid a situation where a non-articulating pusher assembly may place uneven pressure on the nail causing it to load into the nail gun in an improper position. This improper positioning may cause the nail to be driven incorrectly leaving further work to be done by the operator to ensure that the nail is secure in its position within a work piece.

It is to be understood that both the forgoing general description and the following detailed description are exemplary and explanatory only and are not restrictive of the invention as claimed. The accompanying drawings, which are incorporated in and constitute a part of the specification, illustrate an embodiment of the invention and together with the general description, serve to explain the principles of the invention.

### BRIEF DESCRIPTION OF THE DRAWINGS

The numerous advantages of the present invention may be better understood by those skilled in the art by reference to the accompanying figures in which:

FIG. 1 is an illustration of an articulating pusher assembly in accordance with an exemplary embodiment of the present invention.

FIG. 2 is an exploded view of the articulating pusher assembly;

FIG. 3 is an illustration of an adjustable angle magazine including the articulating pusher assembly in accordance with an exemplary embodiment of the present invention;

FIG. 4 is a side view illustration of the articulating pusher assembly;

FIG. 5 is an illustration of the articulating pusher assembly engaging a collated nail strip of round-head nails;

FIG. 6 is an illustration of the articulating pusher assembly engaging a collated nail strip of clipped-head nails;

FIG. 7 is an expanded isometric view of the articulating pusher assembly disposed in the adjustable angle nail gun magazine; and

FIG. 8 is an illustration of an adjustable angle nail gun employing the present invention in accordance with an exemplary embodiment of the present invention.

### DETAILED DESCRIPTION OF THE INVENTION

Reference may now be made in detail to the presently preferred embodiments of the invention, examples of which are illustrated in the accompanying drawings.

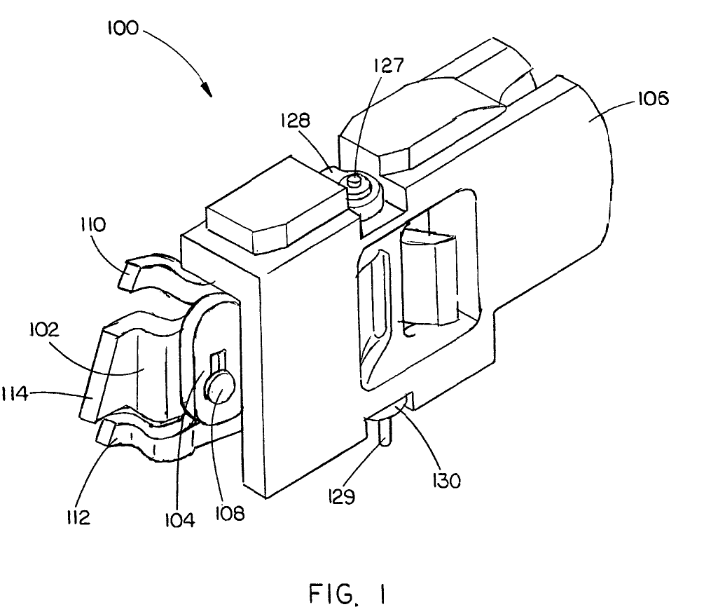

Referring generally to FIGS. 1 through 8, an articulating pusher assembly 100 is shown. The articulating pusher assembly 100 includes an articulating pusher 102 and an adapter 104. The articulating pusher assembly 100 further includes a casing 106. The articulating pusher 102 is coupled with the adapter 104 through use of a pin 108 and the adapter 104 engages with the casing 106 to provide stability. A first mounting arm 128 and a second mounting arm 130 are included on the adapter 104. The first and second mounting arms 128 and 130 engage with the casing 106 through the use of a fastener, such as a pin, screw, bolt, and the like. In the exemplary embodiments shown, the fasteners comprise a first pin 127 and a second pin 129 which insert through the first and second mounting arms 128 and 130 and into a first pin aperture 131 and a second pin aperture 133 disposed on the casing 106. It is understood that the fastening of the first and second mounting arms to the casing 106 may enable rotational capabilities in the adapter 104. It is contemplated that the engagement of the adapter 104 to the casing 106 may be accomplished using a variety of assemblies as contemplated by one of ordinary skill in the art. An alternative example may include the adapter 104 being disposed with two posts which engage with the first and second pin apertures 131 and 133 of the casing 106. The posts allow for rotation of the adapter and may be secured by fasteners as described above. Another method of engagement may include a compression lock assembly disposed on the adapter 104 which engages the casing 106 by pushing the adapter into place. Still further, a quick release assembly may be employed.

The adapter 104 protrudes through the casing 106. This section of the adapter 104 may be engaged by an operator of the articulating pusher assembly 100. An operator may push on the adapter 104 and in so doing may cause the adapter 104 and the articulating pusher 102 to rotate above the plane of operation thereby disengaging with a nail or a collated nail strip when present. When the operator is ready to engage the nails the adapter 104 is released and the adapter 104 along with the articulating pusher 102 rotate back into the plane of operation. It is understood that the casing 106 is disposed with sufficient space to allow the adapter 104 and the articulating pusher 102 to rotate above and into the plane of operation.

Preferably, the articulating pusher assembly 100 utilizes the pin 108 to couple the articulating pusher 102 to the adapter 104. It is understood that the pin 108 may be a variety of fastening devices, such as a screw, bolt, snap, and the like, which enables the coupling of the articulating pusher 102 to the adapter 104. The pin 108 allows the articulating pusher 102 to rotate against the adapter 104. The adapter 104 further includes a connection member 122 which extends over the articulating pusher 102 and provides engagement with the pin 108. The connection member 122 includes a first aperture 124 for insertion of the pin 108. The aperture 124 lines up with a second aperture 126 disposed on the articulating pusher 102. The pin 108 is allowed to rotate and move within the first and second aperture 124 and 126. The pin 108 may be designed to securely engage with the second aperture 126 or the pin 108 may simply insert through the second aperture 126 relying on the articulating pusher 102 being unable to move in a vertical plane and disengage from the pin 108. The pin 108 may be removable from the articulating pusher 102 and the adapter 104. The adapter 104 and the articulating pusher 102 may be interchangeable with other articulating pusher assemblies. This may be advantageous to an operator in that a single articulating pusher 102 or adapter 104 may be employed with a variety of devices enabling those devices as multi-functionality tools.

The articulating pusher 102 is preferably shown to include a first arm 110 and a second arm 112. The first and second arms 110 and 112 operably engage the articulating pusher assembly 100 with nails. A third arm 114 also operably engages with nails, however, the manner of engagement is somewhat different than that of the first and second arms and is described below. The articulating pusher further comprises a back end 116. Preferably, the back end 116 is curved to enable engagement of the articulating pusher 102 with the adapter 104. The adapter 104 includes a first curved engagement section 118 and a second curved engagement section 120. These two sections engage with the back end 116 of the articulating pusher 102. The first and second sections 118 and 120 allow for rotation of back end 116. These two sections assist in enabling the articulating pusher 102 to rotate relative to the adapter 104.

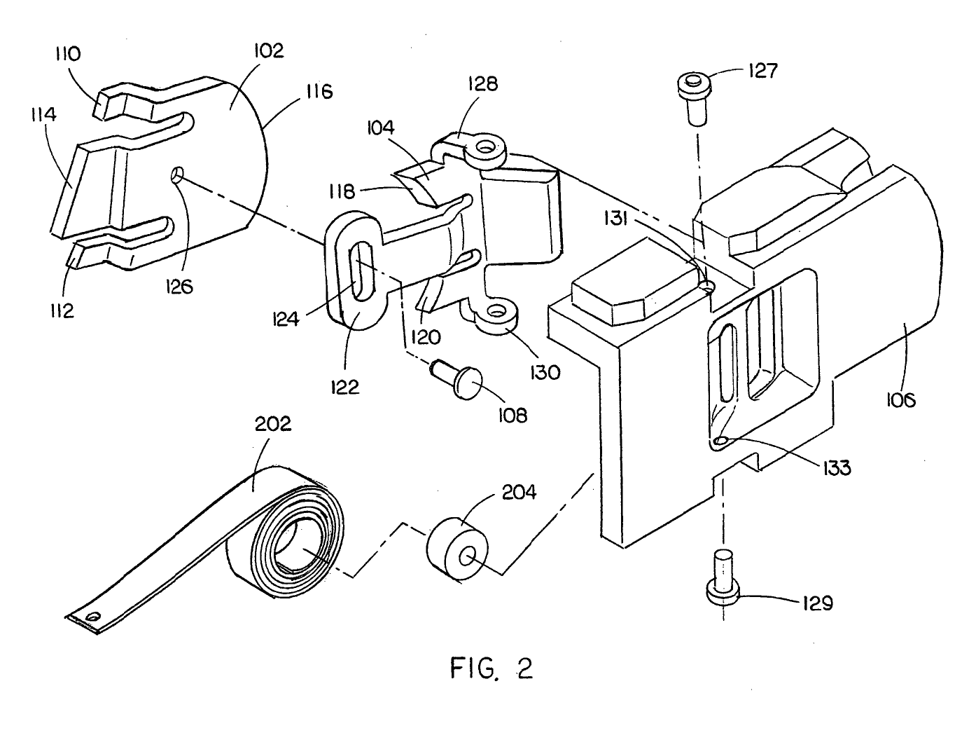

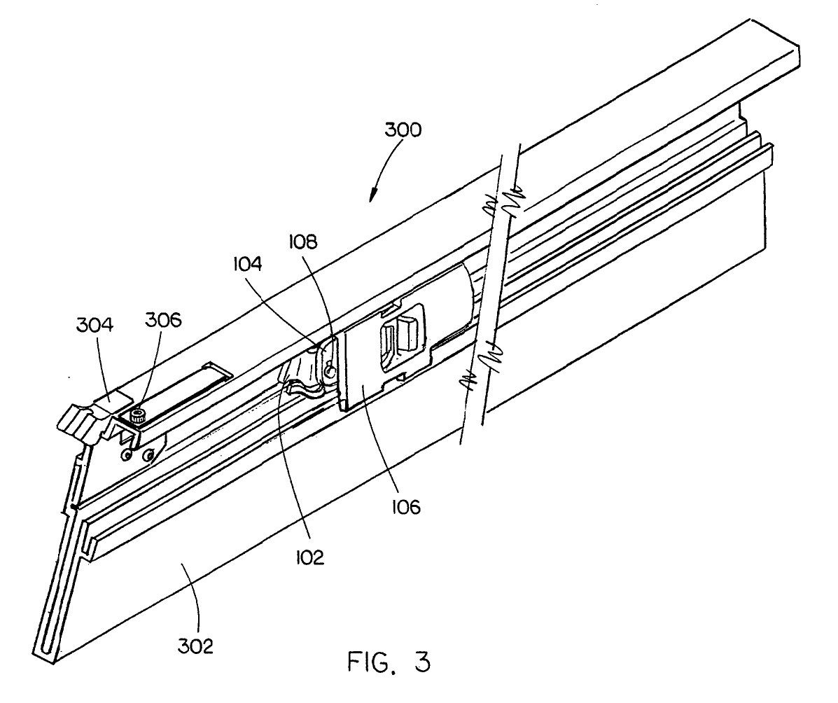

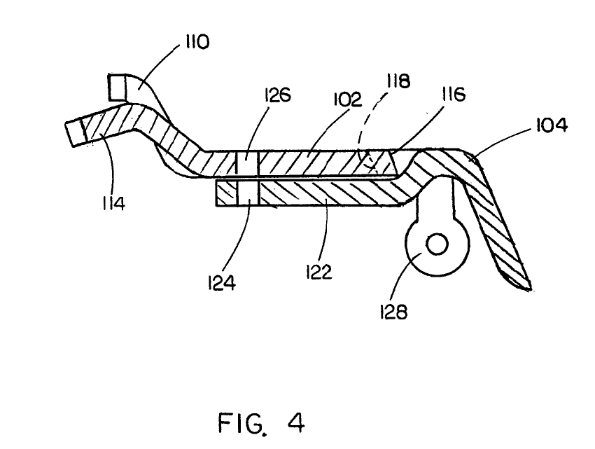

The exploded view of the articulating pusher assembly 100, shown in FIG. 2, illustrates a tension spool assembly included within the articulating pusher assembly 100. The tension spool assembly includes a spool 202 wrapped around an axle 204. The spool 202 and the axle 204 are affixed within a back end of a casing 106 of the articulating pusher assembly 100. The spool 202 is further affixed to the housing of a nail loading assembly, such as an adjustable angle magazine, as may be shown and described in FIGS. 3 and 4.

An adjustable angle magazine 300 including the articulating pusher assembly 100, is shown in FIGS. 3 and 4. The adjustable angle magazine 300 includes a housing 302, which is disposed with the articulating pusher assembly 100 and a universal adapter assembly 304. The adjustable angle magazine 300 provides the operator of a nail gun the ability to use different types of nails within the same nail gun. The casing 106 of the articulating pusher assembly engages with the housing 302 of the adjustable angle magazine 300.

The articulating pusher assembly 100 is loaded into the housing 302 through the end opposite of the universal adapter assembly 304. The articulating pusher assembly 100 is enabled to move within the housing 302. The movement is a sliding movement up and down the length of the housing 302. The spool 202 disposed in the casing 106 couples with the housing 302. Preferably, the coupling of the spool 202 with the housing 302 is enabled by a bolt 306 fastened in place with a nut. The bolt 306 extends through the housing 302 to engage with the nut and hold the spool 202 securely in place. In the exemplary embodiment the spool 202 extends through the housing 302 before being engaged by the bolt 306. It is understood that the spool 202 may engage with the housing 302 and bolt 306 without extending through the housing 302 or may extend through the housing 302 in a location that differs from the one shown without departing from the scope and spirit of the present invention.

The spool 202 is of sufficient length to enable the articulating pusher assembly 100 to be moved up and down the length of the housing 302 and be removed from the housing 302. The spool 202 is composed of a material which allows it to be unspooled and then retract to a spooled position. Thus, the spool 202 may be composed of various materials, such as steel, aluminum, and the like. Preferably, the spool 202 is configured as a flat, thin piece of metal which may be disposed within the housing 302. The spool 202 may be removed from the housing 302 by releasing the bolt 712 and nut 714. It is understood that the spool 202 may be integrated with the housing 302 at one end in order to provide an anchor. Further, the spool 202 and the axle 204 may be removed from the housing of the articulating pusher assembly 100. This may enable the spool 202 and the axle 204 to be employed in multiple articulating pusher assemblies.

The spool 202 provides a constant pressure to the articulating pusher assembly 100 when engaged within the housing 302 of the adjustable angle magazine 300. This constant pressure enables the articulating pusher assembly 100 to push nails, loaded into the adjustable angle magazine 300 down the length of the housing 302 and into a nail gun for driving. It is understood that the nails may be loaded into the adjustable angle magazine 300 through the end of the magazine opposite its coupling with a nail gun. Thus, the adjustable angle magazine 300 is enabled as an end-loading magazine. The force applied by the spool 202 is a result of the tensile strength of the material used for the spool 202. Thus, different material with different tensile strengths may apply differing pressures to the articulating pusher assembly 100. It is understood that materials which provide a wide range of tensile strengths may be employed in the present invention without departing from its scope and spirit.

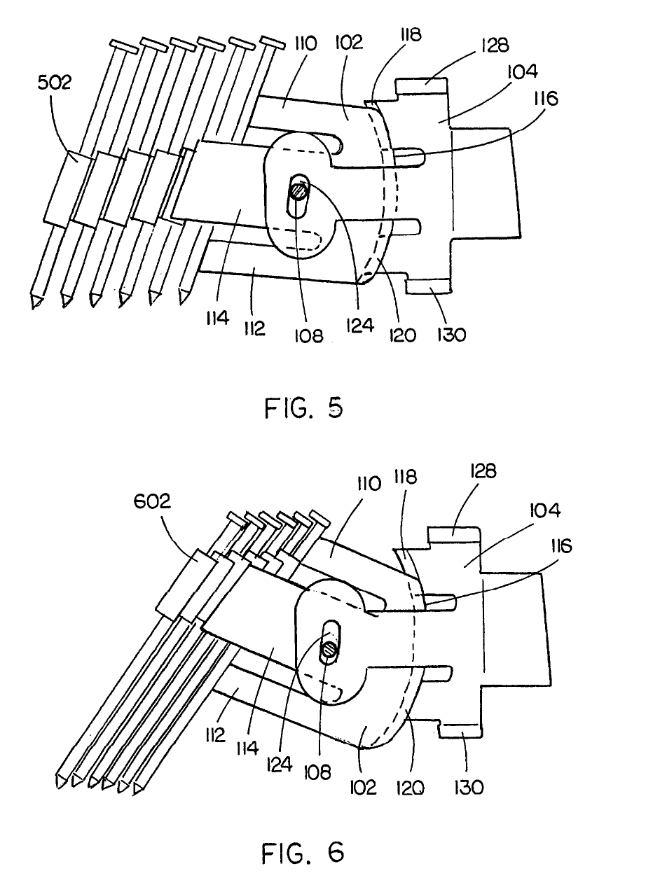

In FIGS. 5 and 6 the articulating pusher assembly 100 is shown engaged with a collated nail strip of round-head nails 502. The articulating pusher 102 rotates relative to the adapter 104 upon engagement with the collated nail strip 502. Rotation is enabled until the articulating pusher has fully engaged the nails. Full engagement of the nails occurs when both the first arm 110, second arm 112 and third arm 114 of the articulating pusher 102 have engaged with the nail. As is seen in FIGS. 5 and 6 the amount of rotation of the articulating pusher 102 relative to the adapter 104 may vary greatly. In FIG. 6 the articulating pusher 102 is engaged with a collated nail strip of clipped-head nails 602. These nails require a much more severe rotation angle by the articulating pusher 102 in order to achieve full engagement.

The amount of rotation enabled by the articulating pusher assembly may be limited in a variety of ways. For instance, the size of the first aperture 124 may be increased or reduced in order to effectuate the desired range of motion allowable by the present invention. The shaping of the back end 116 of the articulating pusher 102 may be configured to allow a defined range of motion. The range of motion may be enabled from zero to ninety degrees. Preferably a range of zero degrees to sixty nine degrees in order to accommodate round-head and clipped-head nails.

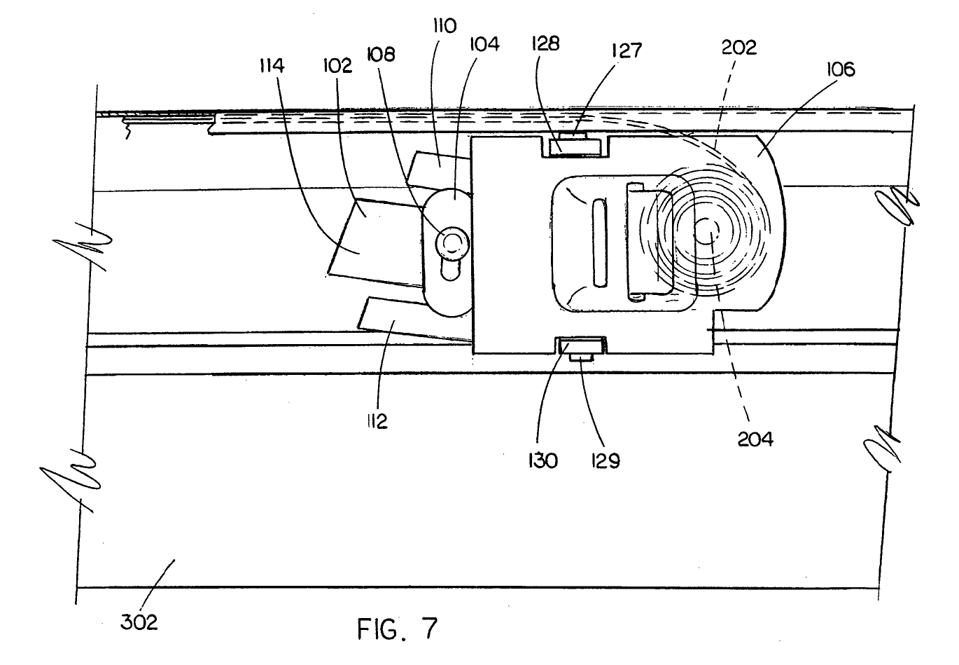

FIG. 7 illustrates the articulating pusher assembly 100 disposed within the housing 302 of the adjustable angle magazine 300, shown and described above in FIG. 3. The first arm 110 and the second arm 112 of the articulating pusher may be preferably configured to provide a representative angle across their faces. For example, the first arm 110 may present at a fifty four degree angle relative to the second arm 112. This enables the articulating pusher 102 to engage with clipped-head nails without requiring rotation relative to the adapter 104. This in turn may limit the range of motion needed to be enabled by the articulating pusher assembly to an exemplary range of fifteen degrees. It is understood that the first and second arms 110 and 112 engage in a pushing manner with the shank of the nails. It is understood that the third arm 114 is preferably configured to engage with the shank of the nails by extending above the plane of the nails and providing vertical support.

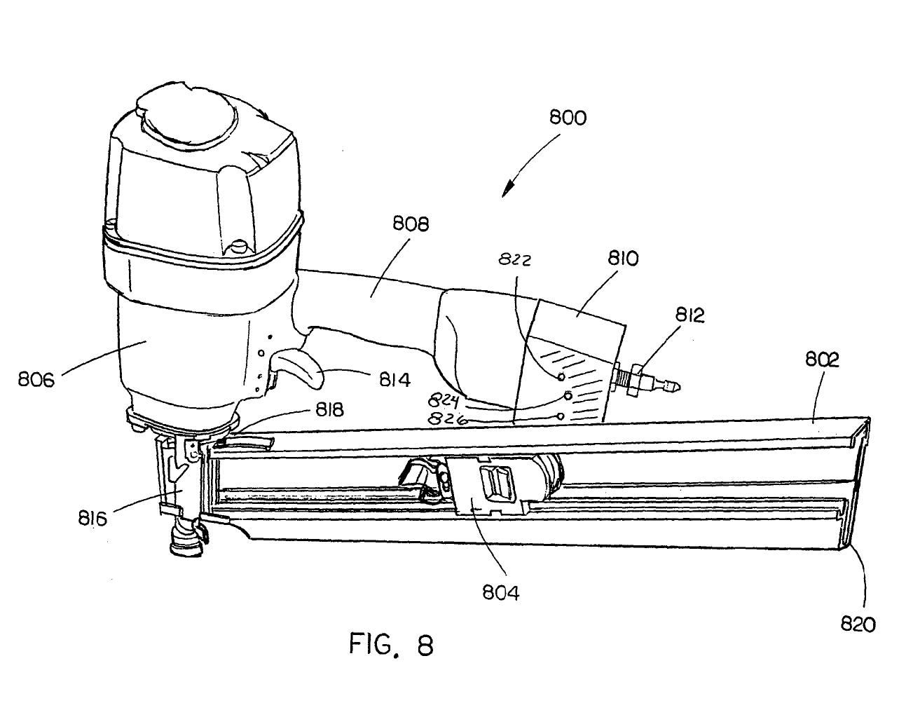

In FIG. 8 a pneumatic nail gun 800 including an adjustable angle magazine 802 disposed with an articulating pusher assembly 804, is shown. The pneumatic nail gun 800 comprises a housing 806 which is coupled with a handle 808. The handle 808 is coupled with a fastening assembly 810 and an air compressor adapter assembly 812. It is understood that the air compressor adapter assembly 812 may be coupled through the fastening assembly 810 to the handle 808. Disposed within the housing is a nail driving assembly including a driver blade. The nail driving assembly is actuated by a trigger 814. Coupled to the housing 806 and operably engaging the driver blade of the nail driving assembly is an adjustable angle nose casting assembly 816.

The fastening assembly 810 includes a plurality of angular adjustment sites, as exemplified by a first angular adjustment site 822, a second angular adjustment site 824 and a third angular adjustment site 826. The fastening assembly 810 is disposed with a plurality of angle identifiers. The angle identifiers are a series of indicators associated with a printed number (i.e., 30, 29, 28, 27 . . . ) which corresponds to the angle of presentation of the adjustable angle magazine 802 to the adjustable angle nose casting assembly 816. It is contemplated that the angle identifiers may be a label with the numbers printed upon them which may be adhered to the fastening assembly 810. Alternatively, the numbers may be engraved or painted upon the fastening assembly 810.

In the current embodiment, it is understood that the plurality of angular adjustment sites may be engaged by a fastener, such as a bolt, screw, pin, and the like. The fastener may engage through the housing 806 via an adjustment assembly comprising a first angular connection site and a second angular connection site. Alternatively, the number of angular connection sites may vary as contemplated by one of ordinary skill. The fastener engages through the first or second angular connection site and connects with one of the plurality of angular adjustment sites.

In an alternative embodiment, the fastening assembly employed by the present invention may be variously configured. For example, the fastening assembly may be implemented using a worm drive assembly. In such a configuration, a threaded shaft may be disposed within the fastening assembly and operationally coupled with a threaded sleeve. The threaded sleeve may be enabled to move up and down the threaded shaft through rotation of a mechanical rotation assembly, which couples with the threaded shaft, by an operator of the nail gun. Other configurations may include a pneumatic fastening system, hydraulic fastening system, alternative mechanical systems, and the like. For instance, the fastening assembly may utilize the compressed air provided through the compressor connection assembly by redirecting the flow of a portion of the compressed air into a gauge assembly. The gauge assembly may include a readout which provides a visual indication to the operator of the angle of the nail loading assembly relative to the adjustable angle nose casting assembly of the adjustable angle nail gun. Further, the gauge assembly may include an actuator which may allow the operator of the adjustable angle nail gun to alter the flow of the compressed air into the gauge assembly either increasing or decreasing the flow. Alternatively, the gauge assembly may provide a bleed-off valve assembly enabling the operator to regulate the release of the compressed air in the gauge assembly. Either by increasing and decreasing the air flow or bleeding-off the compressed air the operator may change the angle of the adjustable angle magazine relative to the adjustable angle nose casting assembly. The gauge assembly may control the angle of the adjustable angle magazine via a piston assembly engaging with the housing of the adjustable angle magazine. The piston assembly may include a piston engaging a shaft which is coupled with the housing, thus, as the shaft moves so to does the housing of the adjustable angle magazine. It is understood the piston moves the shaft by reacting to changing air pressures within.

In an alternative embodiment, a mechanical fastening system may include a ratchet assembly with a hand brake. The hand brake is engaged by the operator and through pressure applied to the hand brake the ratchet assembly raises or lowers the housing of the adjustable angle magazine. For example, the hand brake may include a spring loaded snap joint which provides incremental adjustments of the angle of the housing relative to the adjustable angle nose casting assembly. The spring loaded snap joint engages a multi-position actuator which engages the ratcheting assembly. The hand brake may be disposed on the handle of the nail gun assembly to provide easy access and control over the nail gun assembly during operation of the hand brake.

It is understood that the adjustable angle magazine 802 is coupled with a universal adapter assembly which pivotally couples with the adjustable angle nose casting assembly 816 in a cradle. A cradle fastening assembly which allows for the pivoting coupling between the adjustable angle magazine 802 and the adjustable angle nose casting assembly 816 is disposed proximal to the cradle. The cradle provides a defined receiving area, within the adjustable angle nose casting assembly 816, including a first and second engagement ledge. The first and second engagement ledges are engaged by a first and second arm of a seating member of the universal adapter assembly. A rail member and transition plate further couple with the seating member enabling the coupling of the universal adapter assembly with the adjustable angle magazine 802. A cradle fastening assembly, including a pin which operationally couples through a first and second pin receiver, engages with the adjustable angle magazine 802. The pin engages with a notch, disposed in the first and second arm of the universal adapter assembly, during operation of the pneumatic nail gun 800 to prevent the adjustable angle magazine 802 from disengaging with the adjustable angle nose casting assembly 816 of the pneumatic nail gun 800. In this manner the pneumatic nail gun is enabled as an adjustable angle nail gun with features similar to those shown and described in the U.S. Provisional Applications Ser. Nos. 60/411,563 and 60/471,641 from which the present application claims priority.

The adjustable angle magazine 802 includes a first end 818 and a second end 820. As mentioned above, the first end 818 pivotally couples with the adjustable angle nose casting assembly 816 through a universal adapter assembly. In the present embodiment the adjustable angle magazine 802 loads nails into the second end 820. Thus, it is understood that the articulating pusher assembly 804 is movably disposed within the adjustable angle magazine 802 and removable from the adjustable angle magazine 802 to allow for the loading and unloading of nails.

In an alternative embodiment the adjustable angle magazine 802 may comprise a cover enabled to couple with the housing 806. It is understood that the cover may engage with the housing via a variety of mechanism, such as sliding mechanism, compression mechanism, or the like. The size of the housing 806 and the cover may vary to accommodate nails of various configurations.

The adjustable angle magazine 802 provides the operator of a nail gun the ability to use a variety of nail types collated at a variety of angles within the same nail gun. The housing 820 is configured generally to appear as a standard nail gun magazine with the cover slidably coupling with it. The housing 820 may be configured for operation without the cover. In alternative embodiments, the housing 820 may be coil-type casing where the connected nails are arranged in a long belt, which winds around a spool. The coil-type casing may be configured in a variety of ways, such as a horizontal coil-type casing or a vertical coil-type casing. The cover may be configured to operate with alternative embodiments, such as the coil-type casing, or may not be included. It is understood that alternative design embodiments of the housing 820 and cover may be employed and do not depart from the scope and spirit of the present invention.

In an alternative embodiment, the pneumatic nail gun 800 may be a spring-loaded nail gun assembly. The spring-loaded nail gun assembly utilizing electricity to drive a motor which engage a spring that drives the driver blade. In another embodiment, the pneumatic nail gun 800 may be an electromagnetic nail gun assembly utilizing a solenoid to provide the driving force to the driver blade. The solenoid may include an electromagnetic coil with a sliding piston inside it. Other embodiments of the solenoid may include a spring assembly to draw the piston back in. In a still further embodiment, the pneumatic nail gun 800 may be a combustion nail gun assembly utilizing a piston driven by the firing of gas in a combustion chamber to drive the driver blade. It is contemplated that the nail gun may be configured as a motor driven nail gun. Thus, the nail gun may be configured with electric motors and the like. Further, the motors may include clutch assemblies for providing the needed force to operate the driver blade and drive a nail. The configuration of the motor and clutch assemblies employed may vary as contemplated by one of ordinary skill in the art without departing from the scope and spirit of the present invention.

It is contemplated that the adjustable angle magazine 802, employing the articulating pusher assembly of the present invention, may be disposed with various other devices and mechanisms. These may include a pick-off pivot assembly, a nail checker assembly, a nail lockout assembly, a nail spacing verification assembly, a nail shank pawl assembly, and a pinion nail verification assembly. Additionally, the adjustable angle magazine may be enabled as a top-loading mechanism, a side-loading mechanism, and the like as may be contemplated by one of ordinary skill in the art.

It is believed that the present invention and many of its attendant advantages may be understood by the forgoing description. It is also believed that it may be apparent that various changes may be made in the form, construction and arrangement of the components thereof without departing from the scope and spirit of the invention or without sacrificing all of its material advantages. The form herein before described being merely an explanatory embodiment thereof. It is the intention of the following claims to encompass and include such changes.

1. An articulating pusher assembly for use in a nail loading assembly of a nail gun, comprising:
an articulating pusher for engaging a nail loaded into the nail loading assembly;
an adapter pivotally coupled with the articulating pusher, the adapter for guiding the articulating pusher;
a casing coupled with the adapter, the casing for slidably coupling with the nail loading assembly; and
a spool assembly coupled with the casing and the nail loading assembly, the spool assembly for enabling the movement of the casing within the nail loading assembly,
wherein the articulating pusher is enabled to pivot upon contacting the nail to fully engage the nail.

2. The articulating pusher assembly of claim 1, wherein the nail loading assembly further comprises a housing coupled with a cover.

3. The articulating pusher assembly of claim 1, wherein the nail loading assembly is an adjustable angle magazine including a universal adapter assembly and an adjustment assembly.

4-9. (canceled)

10. The articulating pusher assembly of claim 3, wherein the adjustable angle magazine is a top-load magazine, end-load magazine, or a side-load magazine.

11. The articulating pusher assembly of claim 3, wherein the adjustable angle magazine is a modular adjustable angle magazine.

12. The articulating pusher assembly of claim 1, wherein the nail gun is selected from the group consisting of a spring-loaded nail gun, a pneumatic nail gun, an electromagnetic nail gun, a combustion nail gun, and a motor driven nail gun.

13. The articulating pusher assembly of claim 1, wherein the nail gun further comprises a clutch assembly.

14-36. (canceled)

37. An articulating pusher assembly for use in a nail loading assembly of a nail gun, comprising:
means for coupling with the nail loading assembly;
means for engaging a nail within the nail loading assembly coupled with the means for coupling with the nail loading assembly, the engaging means being enabled to pivot upon contacting the nail to fully engage the nail,
wherein the means for coupling with the nail loading assembly is a casing coupled with a spool assembly, the spool assembly also coupled with the nail loading assembly, the casing further rotationally coupled with an adapter.

38. (canceled)

39. The articulating pusher assembly of claim 37, wherein the means for engaging a nail is an articulating pusher pivotally coupled with the means for coupling with the nail loading assembly.

40. The articulating pusher assembly of claim 37, wherein the nail loading assembly is an adjustable angle magazine.

41. The articulating pusher assembly of claim 40, wherein the adjustable angle magazine further comprises a universal adapter assembly.

42-46. (canceled)

47. The articulating pusher assembly of claim 40, wherein the adjustable angle magazine is a top-load magazine, end-load magazine, or a side-load magazine.

48. The articulating pusher assembly of claim 40, wherein the adjustable angle magazine is a modular adjustable angle magazine.

49. The articulating pusher assembly of claim 37, wherein the nail gun is selected from the group consisting of a spring-loaded nail gun, a pneumatic nail gun, an electromagnetic nail gun, a combustion nail gun, and a motor driven nail gun.

50. The articulating pusher assembly of claim 37, wherein the nail gun further comprises a clutch assembly.

51. An articulating pusher assembly for use in a nail loading assembly of a nail gun, comprising:
a casing slidably coupled within the nail loading assembly;
an adapter pivotally coupled to the casing; and
an articulating pusher configured to engage a nail loaded into the nail loading assembly, the articulating pusher rotatably coupled to the adapter,
wherein the articulating pusher is constructed to rotate relative to the adapter upon contacting the nail to fully engage the nail.

52. The articulating pusher assembly of claim 1, wherein the adapter is selectively pivotable to rotate into a plane of operation which includes the nail.

53. The articulating pusher assembly of claim 37, wherein the adapter is selectively pivotable to rotate into a plane of operation which includes the nail.

54. The articulating pusher assembly of claim 51, wherein the adapter is selectively pivotable to rotate into a plane of operation which includes the nail.
